(19) United States
(12) Patent Application Publication
(10) Pub. No.: US 2011/0233349 A1
(43) Pub. Date: Sep. 29, 2011

(54) SUPPORT FRAME

(75) Inventors: HAI-QING ZHOU, Shenzhen (CN); SONG-LIN TONG, Shenzhen (CN)

(73) Assignees: HONG FU JIN PRECISION INDUSTRY(ShenZhen) CO., LTD, Shenzhen City (CN); HON HAI PRECISION INDUSTRY CO., LTD., Tu-Cheng (TW)

(21) Appl. No.: 12/884,439

(22) Filed: Sep. 17, 2010

(30) Foreign Application Priority Data
Mar. 26, 2010 (CN) 201010133495.7

(51) Int. Cl. F16M 11/04

(52) U.S. Cl. 248/122.1

(57) ABSTRACT

A support frame to support an electronic component of a computer system is provided. The support frame includes four support posts and two pairs of brackets mounted on the support posts. Each bracket includes a bottom surface and two side edges extending from opposite sides of the bottom surface along the same axis. A guide member is slidably mounted between one pair of brackets. The guide member includes a main body and two sliding portions positioned on opposite sides of the main body. A plurality of rolling members is movably mounted between the sliding portion and the corresponding side edges of the at least one pair of brackets. The electronic component is secured to the main body, and generating an amount of roll friction when the electronic component is inserted into or withdrawn from the brackets.

### BACKGROUND

1. Technical Field

The present disclosure relates to system structure and more particularly, to a support frame for a computer system.

2. Description of Related Art

In a server system, a plurality of hard disk drives (HDDs) or servers are arranged in an array, and a support frame is provided inside a housing of the computer system to support one or more electronic components such as the HDD and the server. Typically, a multi-layer frame including a plurality of trays is used, and a HDD is placed on and detachably secured to a tray. However, when withdrawing the HDD from the multi-layer frame, a relatively larger sliding friction is generated between the HDD and the corresponding tray. As a result, the installation and removal of the HDD is not convenient, especially when the HDD is relatively heavy.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of one embodiment of a support frame used to support two hard disk drives.

FIG. 2 is an isometric, exploded view of the support frame of FIG. 1.

FIG. 3 is a partial cross-section of the support frame, taken along the line shown in FIG. 1.

### DETAILED DESCRIPTION

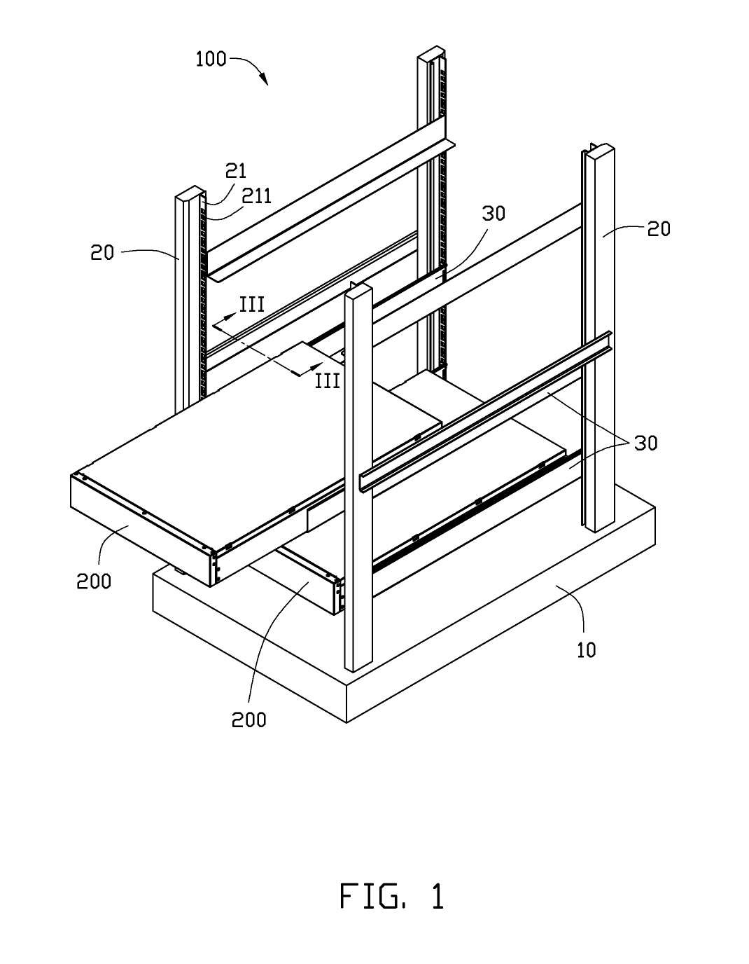

Referring to FIG. 1, one embodiment of a support frame 100 for use in a computer system, such as a server system, is shown. The computer system includes a housing (not shown) and a plurality of hard disk drives (HDDs) 200 received in the housing and supported by the support frame 100. The support frame 100 includes a base plate 10, four support posts 20 arranged in a matrix and substantially perpendicular to the base plate 10, and two pairs of brackets 30 fixed to the support posts 20. Each HDD 200 is mounted between and slidable relative to one pair of brackets 30, thus the HDD 200 can be inserted into or removed from the support frame 100.

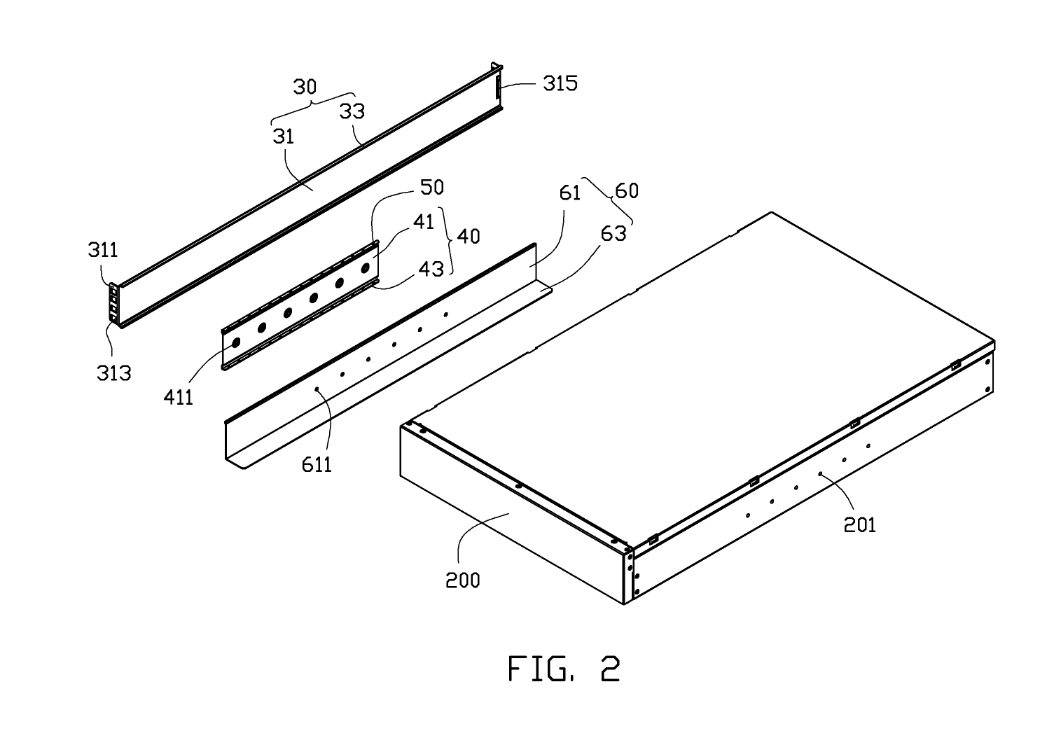

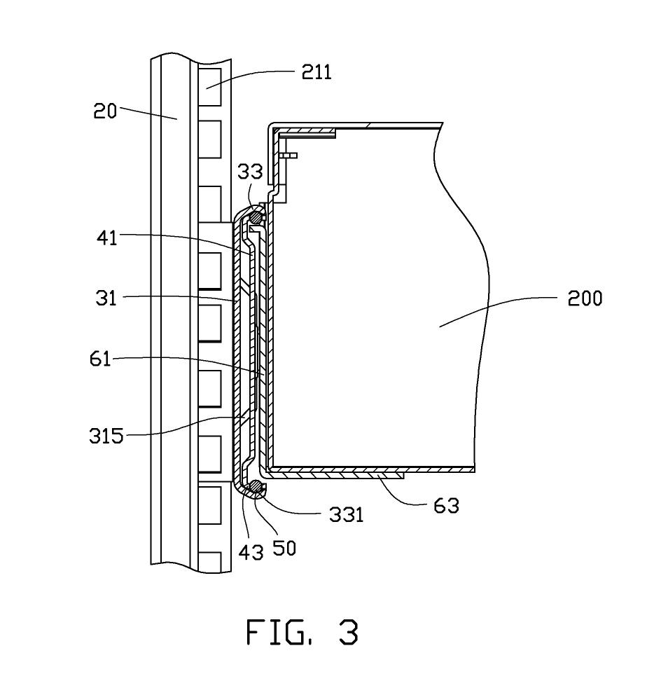

Referring also to FIGS. 2 and 3, each bracket 30 includes an elongated bottom surface 31 and two side edges 33 extending from opposite sides of the bottom surface 31. The side edges 33 extend along the same axis, such that the cross section of the bracket 30 is substantially U-shaped. Each side edge 33 is substantially arcuate and has a contact surface 331 positioned in the inner side thereof. The bottom surface 31 forms two assembly portions 311 disposed on opposite ends thereof, and connecting to the support posts 20. In this illustrated embodiment, each support post 20 defines one or more first assembly holes 211, and correspondingly, each assembly portion 311 defines one or more second assembly holes 313 corresponding to the first assembly holes 211. The bracket 30 is fixed to the support posts 20 via a plurality of fasteners (not shown) received in the first and second assembly holes 211, 313.

The bottom surface 31 includes a stop portion 315 protruding from one end of the bottom surface 31 for retaining the HDD 200 in a predetermined position.

The support frame 100 further includes a guide member 40, and a plurality of rolling members 50 movably mounted on the guiding member 40.

The guide member 40 is an elongated plate, and includes a main body 41 and two sliding portions 43 extending from opposite ends of the main body 41 along the same axis. Each HDD 200 may define a plurality of first fixing holes 201 on opposite sides thereof, correspondingly. The main body 41 defines a plurality of second fixing holes 411. Thus, the HDD 200 is fixed to the guide member 40 via a plurality of fasteners (not shown) received in the first and second fixing holes 201, 411. The distance between the two sliding portions 43 is less than the distance between the two side edges 23 of the bracket 30, such that the guide member 40 can be slidably received in the bracket 30. The rolling members 50 are arranged on the sliding portion 43 at one or more predetermined intervals and contact the contact surface 331 of the bracket 30. When the HDD 200 is fixed to the guide member 40 and slides relative to the bracket 30, friction is generated between the guide member 40 and the bracket 30, thus facilitating the removal and installation of the HDD 200 for maintenance or repair.

In this illustrated embodiment, the support frame 100 further includes a support member 60 for connecting the HDD 200 and the guide member 40. The support member 60 is a substantially L-shaped plate, and includes a fixing portion 61 and a support portion 63 which the HDD 200 is placed on. The fixing portion 61 defines a plurality of though holes 611, and thus the support member 60, the guide member 40, and the HDD 200 can be secured together with a plurality of fasteners (not shown) received in the corresponding first and second fixing holes 411, 611, and the through holes 201.

As described, since the rolling members 50 are movably mounted on the guide member 40 and contact the bracket 30, when the HDD 200 is inserted into the support frame 100, considerably less friction is generated between the guide member 40 and the bracket 30 with less force required to be exerted. When the guiding member 40 abuts the stop portion 315, the HDD 200 is retained in the current position. Similarly, when the HDD 200 is withdrawn from the brackets 30, once again, less force is required, thereby simplifying the operation.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A support frame for use in a computer system to support an electronic component of the computer system, the support frame comprising:
a plurality of support posts;
at least one pair of brackets mounted on the plurality of support posts, each bracket comprising a bottom surface and two side edges extending from opposite sides of the bottom surface along the same axis;
a guide member slidably mounted between the at least one pair of brackets, the guide member comprising a main body and two sliding portions positioned on opposite sides of the main body; and
a plurality of rolling members movably mounted between the sliding portion and the corresponding side edges of the at least one pair of brackets, wherein the electronic component is secured to the main body.

2. The support frame of claim 1, wherein each side edge is substantially arcuate.

3. The support frame of claim 1, wherein each side edge comprises a contact surface positioned in the inner surface thereof, and the contact surface contacting the plurality of rolling members.

4. The support frame of claim 1, wherein the bottom surface forms two assembly portions positioned on opposite ends connecting to the plurality of support posts.

5. The support frame of claim 4, wherein each support post defines at least one first assembly hole, each assembly portion defines at least one second assembly hole corresponding to at least one first assembly hole, and a plurality of fasteners are received in the first and second assembly holes, securing the bracket to the support post.

6. The support frame of claim 1, wherein a stop portion protrudes from an end of the bottom surface contacting the electronic component when moved to a predetermined position.

7. The support frame of claim 1, wherein the plurality of rolling members is arranged on the sliding portion at one or more predetermined intervals.

8. The support frame of claim 1, further comprising a support member comprising a fixing portion secured to the main body, and a support portion.

9. The support frame of claim 1, further comprising a base plate, wherein the plurality of support posts is positioned in a matrix perpendicular to the base plate.

10. A support frame comprising:
a plurality of support posts;
at least one pair of brackets mounted on the plurality of support posts, each bracket comprising a bottom surface and two side edges extending from opposite sides of the bottom surface along the same axis;
a guide member slidably mounted between the at least one pair of brackets, the guide member comprising a main body and two sliding portions positioned on opposite sides thereof; and
a plurality of rolling members movably mounted between the sliding portion and the corresponding side edges of the at least one pair of brackets.

11. The support frame of claim 10, wherein each side edge is substantially arcuate.

12. The support frame of claim 10, wherein each side edge comprises a contact surface positioned in the inner surface thereof to contact the plurality of rolling members.

13. The support frame of claim 10, wherein the bottom surface forms two assembly portions positioned on opposite ends connecting to the plurality of support posts.

14. The support frame of claim 10, wherein the plurality of rolling members is arranged on the sliding portion at one or more predetermined intervals.
